(19) United States
(12) Patent Application Publication
(10) Pub. No.: US 2018/0330604 A1
(43) Pub. Date: Nov. 15, 2018

(54) GATEWAY DEVICE, SYSTEM AND METHOD

(71) Applicant: Alexandros Cavgalar, Wichita, KS (US)

(72) Inventor: Alexandros Cavgalar, Wichita, KS (US)

(21) Appl. No.: 16/042,576

(22) Filed: Jul. 23, 2018

Related U.S. Application Data
(63) Continuation of application No. 15/834,019, filed on Dec. 6, 2017, now abandoned.
Application No. 15/834,019 is a continuation of application No. 13/689,749, filed on Nov. 29, 2012, now abandoned.

(51) Int. Cl. G08C 17/02; G08C 23/04

(52) U.S. Cl. CPC G08C 17/02; G08C 23/04

(57) ABSTRACT

A local network system include one or more terminals operable to act as a client on the local network, wherein at least one terminal is a remote control configured to receive user input; and a gateway device operable to manage communications between the one or more terminals and an external network. The gateway device includes a memory configured to store a set of instructions; a processor configured to execute the set of instructions; a first communications module in communication with the external network; a second communications module for providing communication between the gateway device and at least one terminal; and a third communications module for providing communication between the gateway device and at least one other terminal.

### CROSS-REFERENCE TO RELATED APPLICATION

This application is a Continuation Application of application Ser. No. 15/834,019, filed Dec. 6, 2017, which is a Continuation Application of application Ser. No. 13/689,749, filed Nov. 29, 2012, which claimed the benefit of priority of U.S. Provisional Application No. 61/565,473, filed Nov. 30, 2011.

### BACKGROUND OF INVENTION

This application relates to networked system and in particular gateway devices, systems and methods.

### SUMMARY

It is becoming increasingly common for homes, businesses, etc. to have access to a wide variety of networked or remote services. Illustrative services include Internet service, cellular voice and data services, on-line services, phone services (PSTN, POTS, VoIP, etc.), cable television services, satellite television services, satellite radio services, etc. Unfortunately, it is quite common for at least some of these services to each have their own access point as well as required hardware. As such, homes and businesses are frequently cluttered with numerous wires and cables as well as “electronically cluttered” with a variety of wireless access or communication points. Therefore, there exists a significant need for the ability to combine the access points to a significantly smaller number of access points as well as manage the communications between devices and networks.

The present disclosure includes several embodiments of gateway devices, network systems and methods. In one embodiment, a local network system comprises: one or more terminals operable to act as a client on the local network, wherein at least one terminal is a remote control configured to receive user input; a gateway device operable to manage communications between the one or more terminals and an external network, the gateway device comprising: a memory configured to store a set of instructions; a processor configured to execute the set of instructions; a first communications module in communication with the external network; a second communications module for providing communication between the gateway device and at least one terminal; and a third communications module for providing communication between the gateway device and at least one other terminal.

In another embodiment, A method of employing a remote control in a local network system, the local network system comprising a gateway device and one or more terminals, wherein at least one terminal is a remote control, the method comprises: receiving a user configuration for the remote control; storing the user configuration for the remote control; receiving a user log-on for the remote control; and loading the stored user configuration for the remote control.

In another embodiment, a remote control for use in a local network system, the system comprising a gateway device in communication with one or more terminals and the remote control, the remote control comprises: memory configured to store a set of instructions; a processor configured to execute the set of instructions, wherein the instructions cause the processor to: receive a user configuration for the remote control; and store the user configuration for the remote control.

### BRIEF DESCRIPTION OF THE DRAWINGS

The drawings, when considered in connection with the following description, are presented for the purpose of facilitating an understanding of the subject matter sought to be protected.

FIG. 1 is a first illustrative system.

FIG. 2 is a second illustrative system.

FIG. 3 is a third illustrative system.

FIG. 4 is a fourth illustrative system.

FIG. 5 is a fifth illustrative system.

FIG. 6 is a sixth illustrative system.

FIG. 7 is an illustrative gateway device.

FIG. 8 is an illustrative method for transferring calls between a gateway device and a telecommunications network.

FIG. 9 is an illustrative method for communicating caller ID information.

FIG. 10 is an illustrative method for providing on-demand services.

FIG. 11 is an illustrative method for providing dynamic control of streamed content.

FIG. 12 is an illustrative method for providing parental controls.

FIG. 13 is an illustrative method for providing text messages.

FIG. 14 is an illustrative system employing a remote control.

FIG. 15 is an illustrative method of employing a remote control.

FIG. 16 is an illustrative block diagram of a remote control.

### DETAILED DESCRIPTION

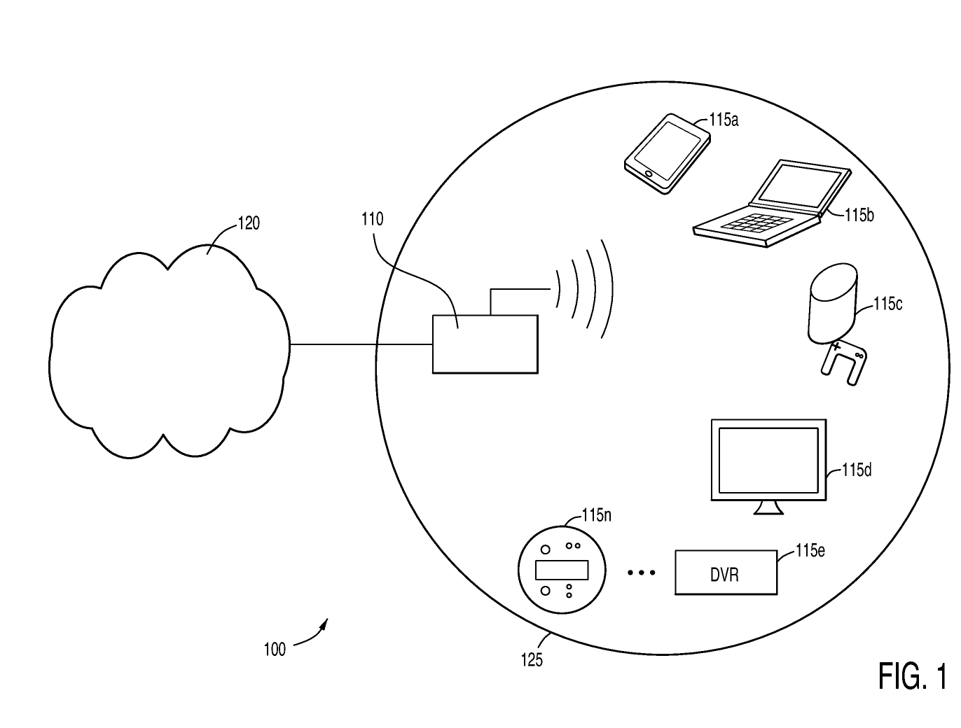

Referring now to the FIGS. wherein like elements are referred to with the same numerals throughout and wherein FIG. 1 illustrates a system 100 in accordance with the present disclosure. The system 100 includes a gateway device 110, one or more terminals 115a-115n (collectively 115), and an external network 120.

The external network 120 may include any number of networks capable of providing communications to and/or receiving communications from the gateway device 110. For example, the external network may be one or more, or any combination of, wireless networks, data or packet networks, publicly switched telephone networks (PSTN), cellular networks, wide area networks (WAN), adjacent local area networks (LAN), etc. In one embodiment, the external network 120 includes the Internet.

The participant terminals 115 may include any suitable device operable to act as a client on a network. Illustrative terminals 115 include, but are not limited to, personal computers, desktop computers, laptop computers, tablet computers, video game systems, servers, any suitable telecommunications device, including, but not limited to, VoIP telephones, smart telephones or wireless devices, such as cellular telephones, personal digital assistants (PDA), communications enabled mp3 players, etc., smart meters, closed circuit television systems, communications enabled televisions, DVRs, set top boxes, satellite radio receivers, printers, copiers, switches, enterprise switches, network access storage (NAS), or any other device suitable to act as a terminal on the local network. The terminals 115 may communicate with the gateway 110 using wireless communications or hardwired connections, such as fiber optics, cable, DSL, telephone lines, and other similar connections.

As will be further discussed below, the gateway device 110 and terminals 115 form a local area network (LAN) 125 such that the gateway device 110 manages communications between the external network 120 and LAN 125. Further, the gateway device 110 is configured to provide communications between and otherwise manage or control communications between the terminals 115 and the external network 120.

The gateway device 110 includes a plurality of communications modules to communicate with one or more of the external network 120 and terminal(s) 115. In one embodiment, the gateway device 110 includes a first communication module configured to communicate with the external network 120. Illustrative first communications modules, include without limitation, a WAN communications module (e.g. any DocSIS, DSL, xDSL, ADSL, ADSL 2, ADSL 2+, VDSL, VDSL2, SHDSL, GbE, ONT, GPON ONT, SPON ONT, EPON ONT, BPON ONT, MoCA, TDM, any T-carrier, any E-carrier, any J-carrier, etc.), a WLAN communications module, an Ethernet communications module, or any other suitable communications module. Additionally, it will be appreciated that the term “module” should be understood broadly so as to encompass any device for communicating with an external network including, but not limited to one or any combination of modems, peripheral cards, modules, on-chip arrangements, transmitters, receivers, transreceivers, etc.

The gateway device 110 further includes one or more communications modules for communicating with one or more terminals 115. The second, third, fourth, etc. communications module(s) for communicating with one or more terminals 115 may include, without limitation, a voice gateway communications module, an Ethernet communications module, a VoIP communications module, a Femto communications module, a Zigbee communications module, a WiFi communications module, WHDMI communications module, print servers, DVR communications module, etc. In one embodiment, one or more of the communications modules is a wireless USB-based communications module (e.g. a wireless WHDMI USB module, etc.). It will be appreciated that any communications module, or any number or combination of communications modules, configured to communicate with one or more terminals may be employed and remain within the scope of the present disclosure.

Suitable illustrative communications modules for communicating with the external network 120 and/or terminals 115 of the system include, without limitation: the PacketAMC board offered by ADAX, Inc.; any of the AMC modules (AM4500, AM4510, AM4520, etc.) offered by Kontron AG; the iSPAN 3639 T1/E1 controller offered by Interphase Corp.; the ETRX3 Zigbee module offered by Telegesis Ltd.; the XB24-Z7PIT-004 module offered by Digi International, Inc.; the Femtocell SoC solution offered by Freescale Semiconductor Inc.; and the Starcore Voice Gateway offered by Freescale Semiconductor Inc. However, it will be appreciated that any suitable device for providing communication between the gateway device 110 and the external network 120 and/or terminals 115 may be employed as any suitable communication module in the system.

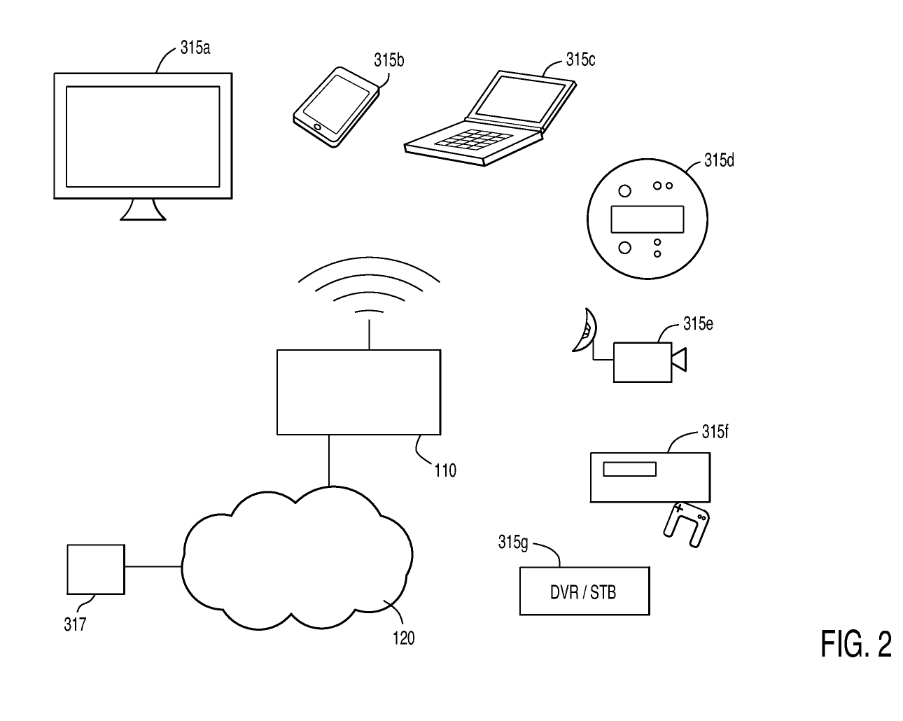

FIGS. 2-6 illustrate several non-limiting examples of the implementation of the system of the present disclosure. It will be appreciated that the following illustrative embodiments are not intended to limit the scope of the disclosure in any way. Each of the illustrative embodiments in FIGS. 2-6 illustrate a variety of terminals in several different settings. It will be appreciated that embodiments having a plurality of the same terminal type are expressly contemplated. Additionally, it will be appreciated that additional terminal types not shown may be employed, including but not limited to the various terminals mentioned above. Also, fewer terminals than shown may be employed and that the expression of one terminal type is not at the exclusion of all other terminal types. Also, it will be appreciated that the functionality of the gateway device 110 in one embodiment may be employed in every other embodiment and it will be appreciated that expression of only a certain functionality in one embodiment is not at the exclusion of all other the functionality described in other embodiments herein.

FIG. 2 illustrates the implementation of the gateway device 110 as a home communication and entertainment gateway. In this embodiment, the terminals (collectively 315) include a television 315a, a mobile device 315b, a computer 315c, a smart meter 315d, a security system 315e, a gaming system 315f and a DVR/STB 315g. The gateway device 110 manages communications between the terminals 315 and external network 120. For example, the gateway device 110 may permit access to the external network 120 by one or more of the terminals 315—this may include, without limitation, providing communications between one or more of the terminals and the external network 120 by transferring data between the terminals 315 and network 120, which may include converting the data so that it is usable by the terminals 315 or endpoint in the external network 120, etc. For example, and without limitation, the gateway device 110 may act so as to permit one of the terminals to access the Internet, etc. Additionally, the gateway device 110 may manage communications between the terminals 315. For example, and without limitation, the gateway device 110 may receive a command from one terminal and pass the command to a second terminal such that the second terminal is responsive to the command from the first terminal (e.g. a record command from the mobile device 315b or computer 315c to the DVR/STB 315g, etc.). Furthermore, the gateway device 110 may manage remote access to one of the terminals 315 over the external network 120. For example, and without limitation, a remote device 317 (e.g. mobile device, computer, etc.) may be permitted to access one of the terminals 315 so as to allow control of the terminal (e.g. remote access to control a smart meter 315d, security system 315e, DVR/STB 315g, etc.).

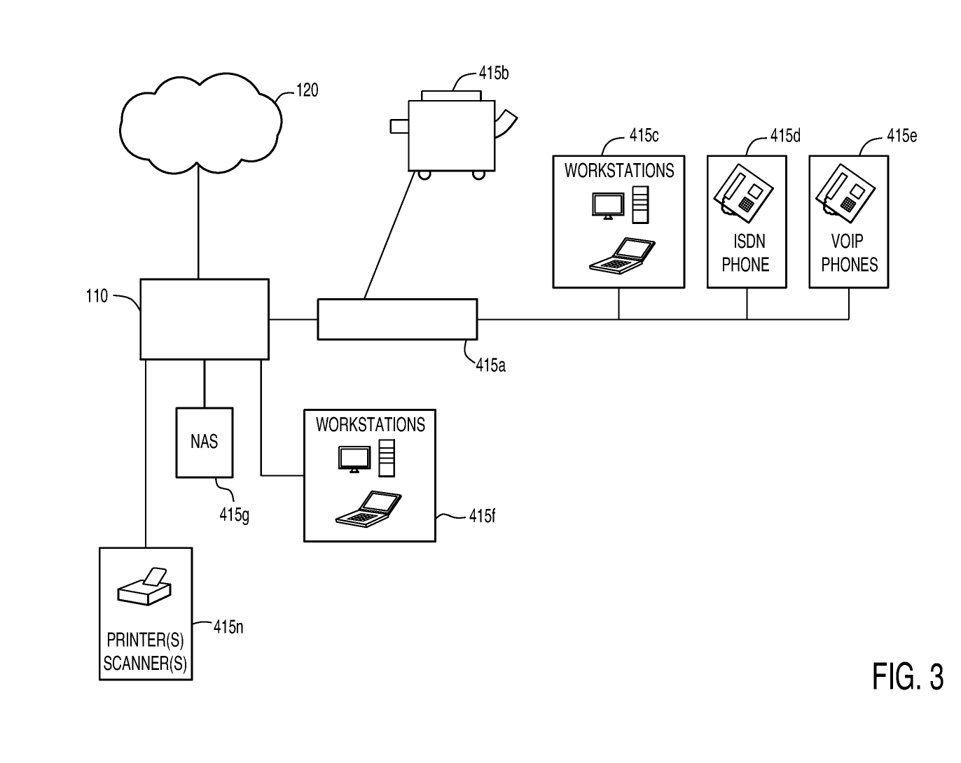

FIG. 3 illustrates the implementation of the gateway device 110 in an office setting. The gateway device 110 may be configured to serve as a small home office gateway, a multi-service business gateway or any other suitable gateway or device. In this embodiment, the terminals (collectively 415) include a switch 415a, such as an enterprise switch, which is connected to devices such as a multifunction device (copier/scanner/printer) 415b, workstations 415c, phones such as ISDN lines 415d or VoIP lines 415e. It will be appreciated that in some instances a switch may not be desirable or necessary and that a switch 415a may not be employed and the terminals placed in direct communication with the gateway device 110. Further, even in instances where a switch 415a is employed, it may still be desirable for certain terminals to be in direct communication with the gateway 110 including, but not limited to, workstations 415f, network access storage (NAS) 415g, printers/scanners 415h, VoIP phone, any Power Over Ethernet (POE) enabled device, etc. The gateway device 110 may manage communications between the external network 120 and the terminals 415 as well as communications between terminals 415.

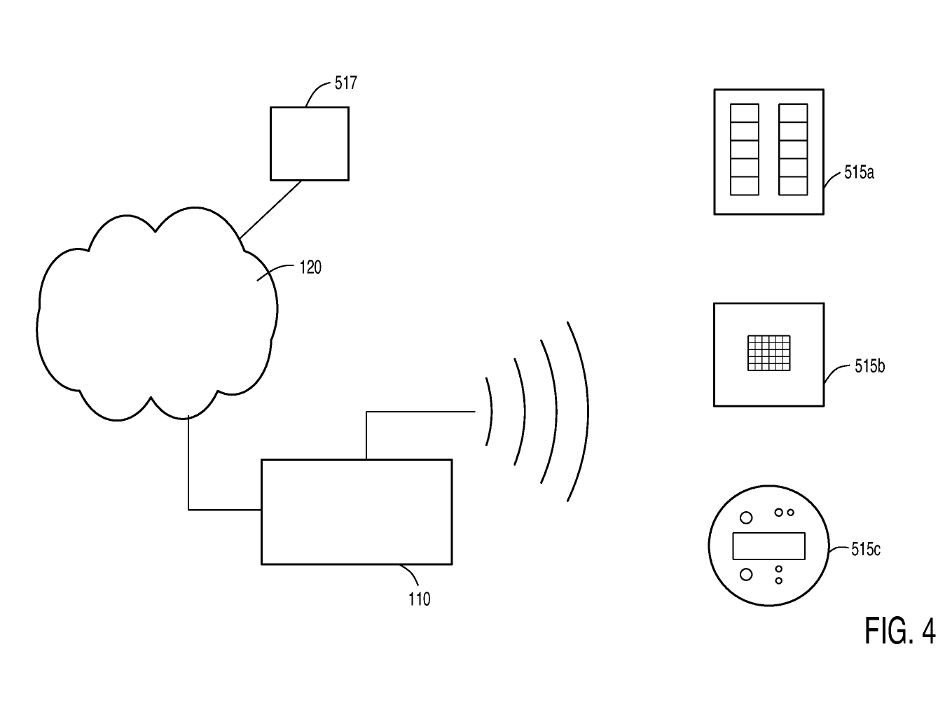

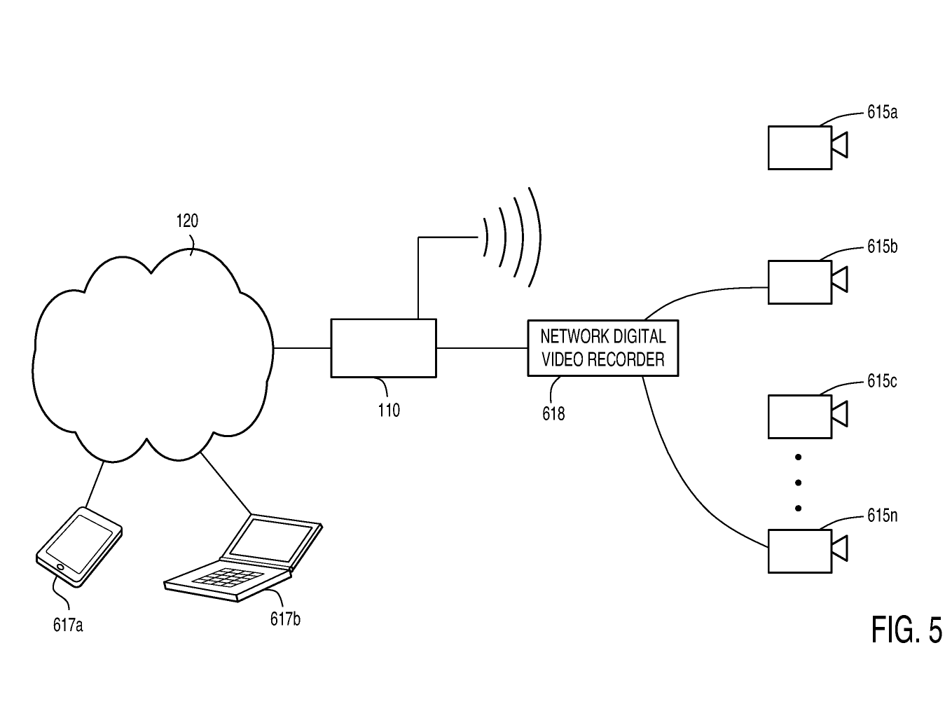

Referring now to FIG. 4, a gateway device 110 is shown in communication with smart meters (collectively 515). As used herein, the term smart meter refers to any device configured to monitor and/or control utilities, utility services, or the like. Illustrative smart meters include, without limitation, smart breaker boxes 515a, lighting control systems 515b, smart electric meters 515c, smart gas meters, smart water meters, industrial PLCs, access control systems, smart appliances, or any other suitable device or devices. In one embodiment, the gateway device 110 manages communications between one or more smart meters 515 such that the meter(s) 515 may be monitored or controlled by another terminal (not show in FIG. 5). Also, in one embodiment, the gateway device 110 may be configured to allow remote access to one or more smart meters 515 over the external network 120 such that a remote device 517 (e.g. mobile device, computer, etc.) may be permitted to access, monitor and/or control the smart meter(s) 515. It will be appreciated that the gateway device 110 provide smart meter management, including but not limited to energy grid management, for home area networks (HAN) as well as field area networks (FAN).

Referring now to FIG. 5, another embodiment employing the gateway device 110 is shown. In this embodiment, the terminals 615a-615n, collectively 615, include components for a closed-circuit television arrangement. In one embodiment, each of the terminals 615 is a camera such as a video camera, infrared camera, FLIR camera, thermographic camera, or any other device or devices suitable for a closed-circuit arrangement. In one embodiment, a terminal is a network digital video recorder 618 to which at least some of the cameras 615 are in communication with. Alternatively, if the gateway device includes persistent storage, the footage from the terminals may be stored thereon. In one embodiment, the gateway device 110 manages communications between other terminals (not shown) and the camera terminals 615 so that the other terminals are able to view, monitor and/or control the camera terminals 615 as well as view recorded footage from the cameras that is stored in the network digital video recorder 618 and/or persistent storage of the gateway device 110. Also, in one embodiment, the gateway device 110 may be configured to allow remote access to one or more of the terminals 615 and/or 618 over the external network 120 such that a remote device (e.g. mobile device 617a, computer 617b, etc.) may be permitted to view, monitor and/or control the camera terminals 615 as well as view recorded footage from the cameras that is stored in the network digital video recorder 618 and/or persistent storage of the gateway device 110. Further, in one embodiment, the gateway device may be configured to enhance the stored video footage so as to enhance the quality of the video or any other suitable aspect or characteristic of the video.

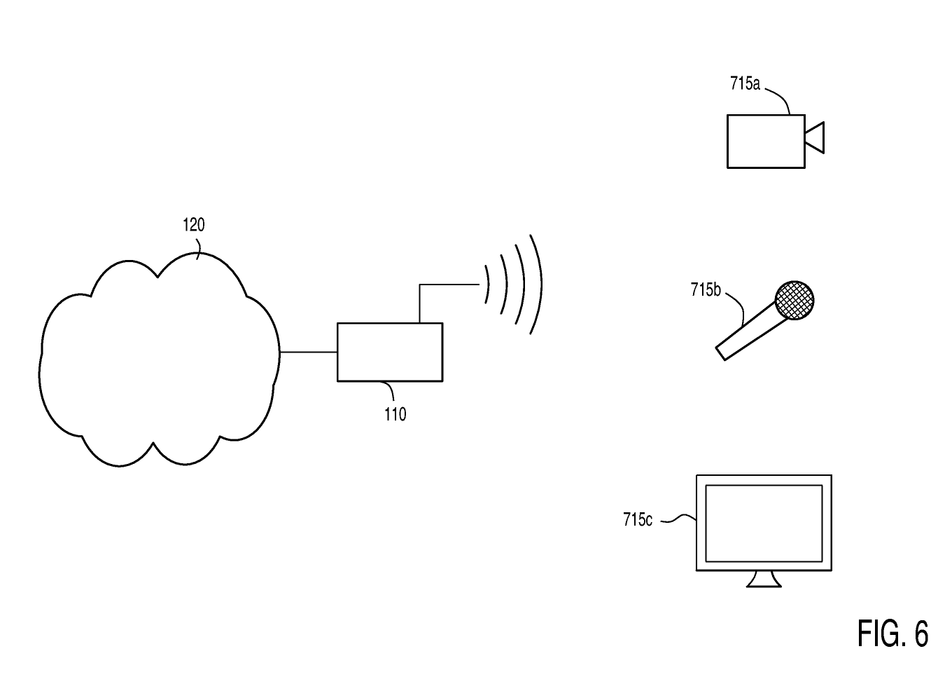

Referring now to FIG. 6, the gateway device 110 may be configured to also act as a unified communication controller. Here, the terminals (collectively 715) may include a video camera 715a, a microphone 715b, and a monitor or television 715c. The terminals may be discrete devices or combined in any suitable combination for an integrated device. The gateway device 110 may be configured to provide communications between each of the terminals 715 and the external network 120 such that the gateway device 110 is operable to provide real time video conferencing.

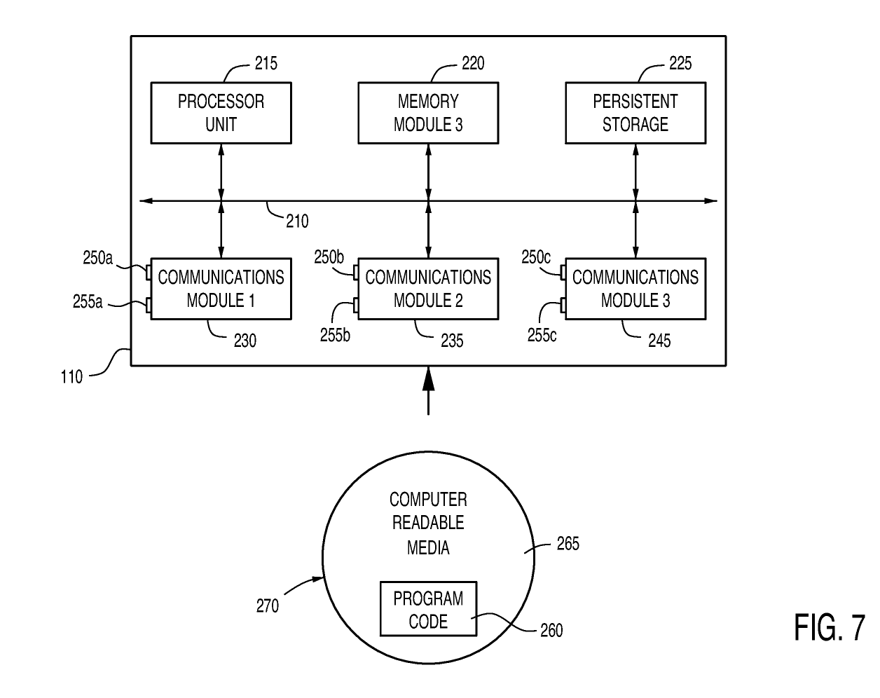

Referring to FIG. 7, a block diagram of a gateway device 110 is shown in which the illustrative embodiments may be implemented. Computer-usable program code or instructions implementing the processes used in the illustrative embodiments described herein, including all methods, may be located on the gateway device 110. The gateway device 110 includes a communications fabric 210, which provides communications between a processor unit 215, a memory 220, a persistent storage 225 the first communications module 230, second communications module 235 and third communications module 240. While three communications modules are shown herein, it will be appreciated that any number of communications modules may be employed and remain within the scope of the present disclosure. Further, it will be appreciated that in some embodiments the gateway device 110 may not include a persistent storage 225.

The processor unit 215 serves to execute instructions for software that may be loaded into the memory 220. The processor unit 215 may be a set of one or more processors or may be a multi-processor core, depending on the particular implementation. Further, the processor unit 215 may be implemented using one or more heterogeneous processor systems in which a main processor is present with secondary processors on a single chip. As another illustrative example, the processor unit 215 may be a symmetric/asymmetric multi-processor system containing multiple processors of the same type.

The memory 220, in these examples, may be, for example, a random access memory or any other suitable volatile or non-volatile storage device. The persistent storage 225 may take various forms depending on the particular implementation. For example, the persistent storage 225 may contain one or more components or devices. For example, the persistent storage 225 may be a hard drive, a flash memory, a rewritable optical disk, a rewritable magnetic tape, or some combination of the above. The media used by the persistent storage 225 also may be removable. For example, a removable hard drive may be used for the persistent storage 225. In one embodiment, the persistent storage 225 also stores video data selectively stored by a user (e.g. as a DVR drive, etc.).

The communications modules 230, 235, 240 will be the communications modules as previously discussed—that is, at least one communications modules is configured to communicate with an external network and at least one module is configured to communicate with one or more terminals. Each module may take any of the forms previously discussed. In one embodiment, one or more of the communications modules includes an ingress connector 250a-250c (collectively 250) and an egress connector 255a-255c (collectively 255). The ingress connector 250 may be configured to test the incoming signal to the communications module without interruption. The egress connector 255 may be configured to test the outgoing signal from the communications module without interruption. Alternatively, an ingress connector and an egress connector may each be connected to the board of the gateway device 110 wherein the memory of the gateway device includes instructions that will allow the incoming and outgoing signals for each communications module to be tested via such connection to the gateway board. Thus, the line connections for each module may be tested.

Instructions for the operating system and applications or programs are located on the persistent storage 225. These instructions may be loaded into the memory 220 for execution by the processor unit 215. The processes or methods of the different embodiments may be performed by the processor unit 215 using computer-implemented instructions, which may be located in a memory, such as the memory 220. These instructions are referred to as program code, computer-usable program code, or computer-readable program code that may be read and executed by a processor in the processor unit 215. The program code in the different embodiments may be embodied on different physical or tangible computer-readable media, such as the memory 220 or the persistent storage 225.

In one embodiment, program code 260 is located in a functional form on a computer-readable media 265 and may be loaded onto or transferred to the gateway device 110 for execution by the processor unit 215. The program code 260 and the computer-readable media 265 form computer program product 270 in these examples.

In one example, the computer-readable media 265 may be in a tangible form, such as, for example, an optical or magnetic disc that is inserted or placed into a drive or other device that is part of the persistent storage 225 for transfer onto a storage device, such as a hard drive that is part of the persistent storage 225. In a tangible form, the computer-readable media 265 also may take the form of a persistent storage, such as a hard drive or a flash memory that is connected to the gateway device 110. The tangible form of the computer-readable media 265 is also referred to as computer recordable storage media.

Alternatively, the program code 260 may be transferred to the gateway device 110 from the computer-readable media 265 through a communication link to a communications module. The communication link or the connection may be physical or wireless in the illustrative examples. The computer-readable media 265 also may take the form of non-tangible media, such as communication links or wireless transmissions containing the program code 260. In one embodiment, the program code 260 is delivered to the gateway device 110 over the Internet.

The different components illustrated for the gateway device 110 are not meant to provide architectural limitations to the manner in which different embodiments may be implemented. The different illustrative embodiments may be implemented in a data processing system including components in addition to or in place of those illustrated for gateway device 110. Other components shown in FIG. 7 can be varied from the illustrative examples shown.

As one example, a storage device in the gateway device 110 is any hardware apparatus that may store data. The memory 220, the persistent storage 225, and the computer-readable media 265 are examples of storage devices in a tangible form.

In another example, a bus system may be used to implement the communications fabric 210 and may be comprised of one or more buses, such as a system bus or an input/output bus. Of course, the bus system may be implemented using any suitable type of architecture that provides for a transfer of data between different components or devices attached to the bus system. Further, a memory may be, for example, the memory 220 or a cache such as found in an interface and memory controller hub that may be present in the communications fabric 210. It will be appreciated that the communications fabric 210 may take any suitable form including, but not limited to, non-blocking switch fabric, non-blocking point-to-point/multi-point link or any other suitable communication fabric of communications path(s) between the various elements.

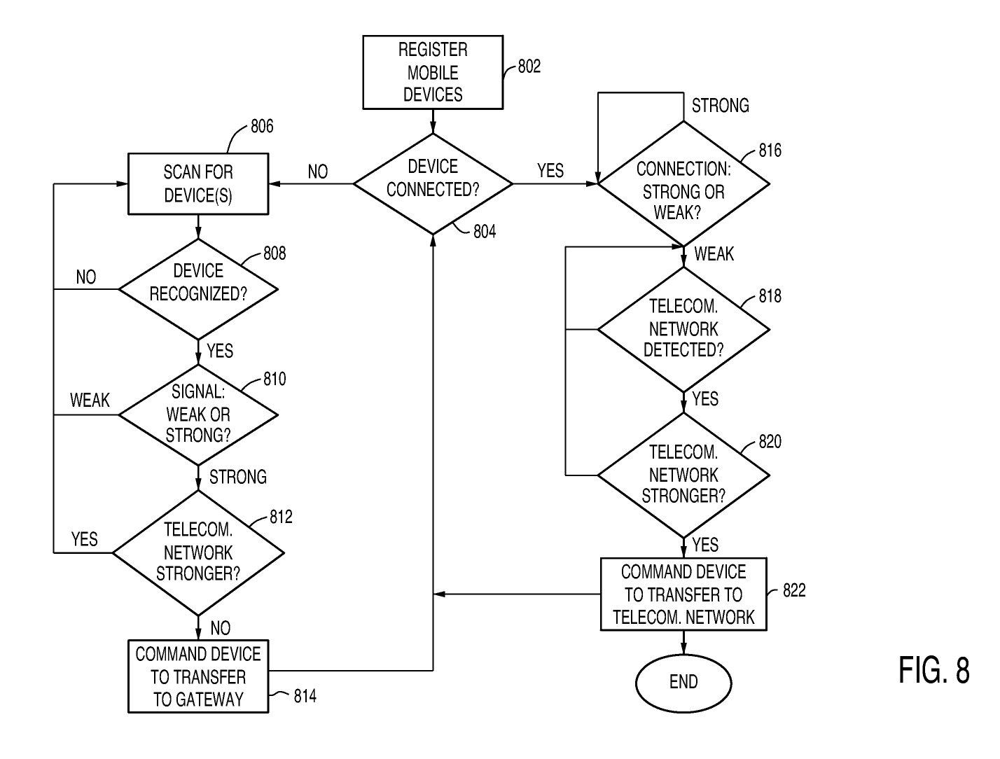

Referring now to FIGS. 8-13, illustrative methods of the gateway device 110 managing communications between the external network 120 and/or between the terminals are shown. It will be appreciated that the terms “managing” and “controlling” are to be understood broadly and encompass not only pushing communications through from the terminal(s) to one or both of another terminal and external network, and vice versa, but also converting data, providing security checks, storing data, caching data and any other means or method for optimizing said communications. Furthermore, while the following methods are discussed individually, it will be appreciated that a gateway device 110 may perform any of these methods, whether simultaneously, sequentially, selectively, user-selectively, etc., and remain within the scope of the present disclosure. Furthermore, the methods may also be employed by any device other than a gateway device as described herein and be considered within the scope of the present disclosure. Also, while the methods may sometimes refer to a single terminal, it will be appreciated that more than one terminal may be employed and remain within the scope of the present disclosure.

Referring now to FIG. 8, a method 800 for transferring calls between a telecommunications network and a gateway device is shown. As used herein, telecommunications network shall be understood broadly so as to encompass any network suitable for providing telecommunications, including but not limited to PSTN, POTS, cellular networks, wireless networks, data or packet networks, or any other suitable network. Further, it will be appreciated that the gateway device is in communications with an external network as described above, telecommunications or otherwise, such that a call may be transferred to or otherwise managed, handled or controlled by the gateway device. Also, the terms “strong,” “relatively strong,” “weak,” and “relatively weak” should be understood broadly so as to encompass a signal or output compared against a predetermined threshold value or a determination of the quality or strength of a signal based on the ability to maintain service within a predetermined quality range, or by any other suitable means or metric for ranking or otherwise determining the strength and/or quality of a signal.

First, a mobile device (also referred to as a terminal), e.g. cellular phones, etc., is registered with the gateway device [step 802]. This will permit the gateway device to only recognize or otherwise provide service to the mobile device registered therewith. Optionally, this step may include installing an application on the mobile device such that the mobile device provides the necessary information to the gateway device (e.g. tower strength, signal strength of telecommunications network, etc.) and/or is responsive to commands from the gateway device (e.g. handover command, etc.), but it will be appreciated that such an application may not always be desirable or necessary.

Once the mobile device(s) have been registered, the gateway device is configured to scan or otherwise recognize mobile devices that become within range of the gateway device [step 804]. In one embodiment, a WiFi and/or a Femto module of the gateway device is employed for scanning or otherwise recognizing mobile devices within range. However, it will be appreciated that any suitable module or device may be used for this purpose. If it is determined that a mobile device is not connected, the gateway will remain in a stand-by mode with respect to this method and/or continue to scan for mobile devices [step 806]. Once a mobile device is detected, the gateway device will determine if the mobile device is recognized as a device having been previously registered with the gateway device [step 808]. In an alternative embodiment where the mobile device is configured to provide an initial communication to a recognized gateway, this step may be optional or not included in the method. If the mobile device is not recognized, the gateway device continues to scan for a recognized mobile device or, alternatively, awaits an initial communication from a previously registered mobile device [step 806]

If the mobile device is recognized by the gateway as a registered mobile device, the gateway device will determine the strength of the signal or communications between the mobile device and the gateway device [step 812]. If the signal is relatively weak, the gateway device may be configured to return to any of the previous steps (e.g. steps 804-810). If the signal is relatively strong, the gateway device will query the mobile device to determine the strength of the signal between the mobile device and the telecommunications network [step 812]. In one embodiment, the mobile device is queried for the relative signal strength between the mobile device and a cellular tower the mobile device is connected to. However, it will be appreciated that the mobile device may be queried about the signal strength between the mobile device and any telecommunications network and remain within the scope of the present disclosure. If the signal strength associated the telecommunications network is stronger than the signal strength between the mobile device and the gateway device, the gateway device may be configured to return to any of the previous step (e.g. steps 804-812).

If the signal strength between the mobile device and the gateway device is stronger, the gateway device will, if necessary, make the necessary connection via the external network such that the call maybe transferred from the telecommunications network to the gateway device without interruption. The gateway device may then command the mobile device to transfer the call to the gateway device [step 814].

The gateway device may further be configured to handover a call from a mobile device in communication with the gateway device to a telecommunications network. If a mobile device is connected to the gateway device [step 804], the gateway device will monitor the signal strength and determine if the signal strength is relatively strong or relatively weak [step 816]. If the signal is relatively strong, the gateway device will maintain the connection and continuously or periodically monitor the signal strength. If the signal strength is relatively weak, the gateway device will determine if a telecommunications network is within range [step 818]. This may be accomplished by the gateway itself or by querying the mobile device to determine if the mobile device detects a telecommunications network. If no telecommunications network is detected, the gateway may be configured to return to any of the previous steps (e.g. steps 804-815).

If a telecommunications network is detected, the gateway device may determine whether the signal or connection with the gateway device is stronger than the signal to the telecommunications network [step 820]. If the signal to the gateway device is stronger, the gateway device may maintain the connection and may be further configured to return to one of the forgoing steps (e.g. steps 804-820). If the signal to the telecommunications network is stronger, the gateway device may command the mobile device to initiate a handover sequence, as is known in the art, so that the call may be transferred from the gateway device to the telecommunications network [step 822]. The method may then be concluded and/or return to step 804.

The forgoing method may be employed in a variety of contexts. In one embodiment, the mobile device is a cellular phone and the telecommunications network is a cellular network whereby the gateway device may transfer a call to or from the telecommunications network to an external network in communication with the gateway device (e.g. PSTN, POTS, VoIP, etc.). In another embodiment, rather than a call being transferred, the connection for streaming data (e.g. YouTube, Hulu, Netflix, etc.) may be transferred (e.g. between a 3G or 4G telecommunications network and an internet connection managed or maintained by the gateway device, etc.).

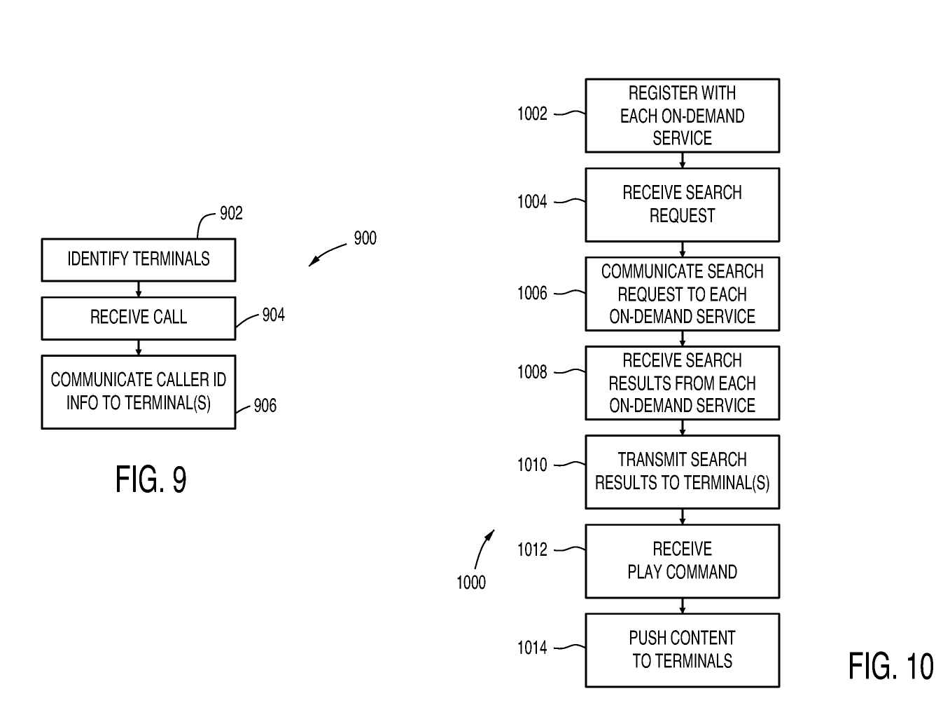

Referring now to FIG. 9, a method 900 for providing caller ID information to one or more terminals is shown. First, one or more terminals are designated to receive caller ID information when an incoming call is received by the gateway device from an external network [step 902]. Next, a call is received wherein the call has caller ID information associated therewith [step 904]. In response thereto, the gateway device communicates the caller ID information to the previously designated devices [step 906].

Referring now to FIG. 10, a method 100 for providing on-demand services to one or more terminals is shown. On-demand services shall be understood to include any service for providing content via an external network to a user or users. Illustrative content includes video, audio, or any other suitable content. Illustrative on-demand service providers include, without limitation, Hulu®, YouTube®, Netflix®, Pandora®, Songza® and the like. First, the registration information for each on-demand service is entered and stored in the gateway device [step 1002]. A search request from at least one terminal may then be received [step 1004]. The search request may then be communicated to each on-demand service via the external network [step 1006]. The search results from each on-demand service may then be received [step 1008]. The search results may then be communicated to one or more terminal(s) [step 1010]. A command, such as play, download, etc., from a terminal may then be received [step 1012]. The gateway device may then push or stream the on-demand content to one or more terminals [step 1014]. It will be appreciated that the gateway device may stream/push the content to the terminal(s) as it is received from the on-demand service, may cache a suitable amount of the content prior to streaming/pushing the content to the terminal(s), store the content in persistent storage and transmit/push the content to the terminal(s) at a later time, etc.

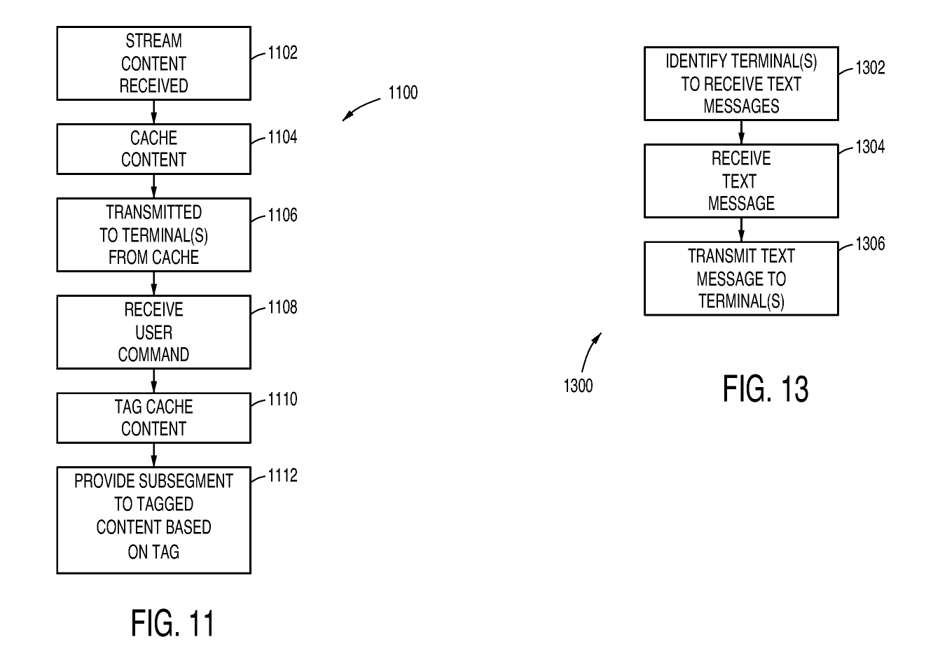

Referring now to FIG. 11, a method 1100 of providing dynamic control of streamed content is provided. First, the gateway device streams content [step 1102]. The content may be streamed from an on-demand source via the external network, from persistent storage, or from any other suitable source (e.g. HD television signal via antenna, etc.). The gateway device will stream the content to a cache, located in memory, persistent storage or other suitable repository, so as to buffer the streaming content [step 1104]. The buffered content may then be pushed or otherwise communicated to one or more terminals [step 1106]. The gateway device may then receive a user command [step 1108]. Illustrative user commands here include, without limitation, pause, record, etc. Upon receiving the user command, the cached content will be tagged in accordance with the user command [step 1110]. The gateway device may later provide access to the tagged content based on the tag [step 1112]. For example, and without limitation, content in cache may be tagged with a pause tag whereby a user may later access the paused content in cache and even from a terminal different than the terminal from which the pause command was made. In another example without limitation, cached content having a record tag may be transferred to persistent storage for subsequent access by the user and even from a terminal different than the terminal from which the record command was made.

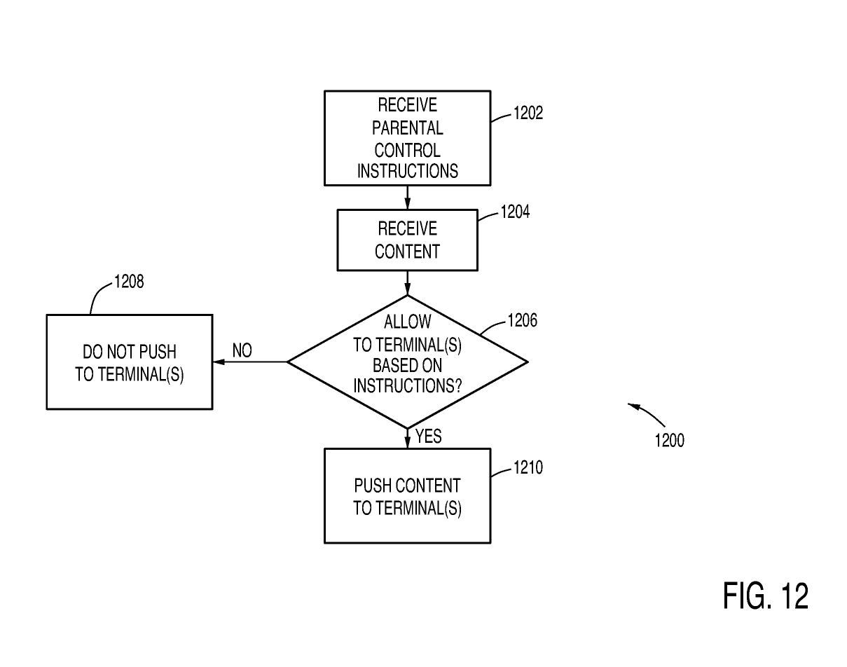

Referring now to FIG. 12 a method 1200 for providing parental control is shown. First, the gateway device receives parental control instructions [step 1202]. The parental control instructions may include restrictions based on any suitable content rating systems, restrictions based on channel, restrictions based on time, or any suitable combination thereof. In one embodiment, the restrictions may also be limited to certain terminal(s) and are not applied equally to all terminal(s). The gateway device may then receive content to be transmitted or pushed to one or more terminals [step 1204]. This content may be received in response to a specific command (e.g to stream/play from a particular external network source, stream/play from persistent storage, etc.) or may be more passive in nature (e.g. channel surfing by a user). The gateway device may then determine if the content is permitted by the terminal(s) according to the parental control instructions [step 1206]. If the content is not permitted to the terminal(s), the gateway device will not stream/push the content to the terminal(s) [step 1208]. If the content is permitted to the terminals, the gateway device will stream/push the content to the terminal(s) [step 1210]. It will be appreciated that this method may be applied to any suitable content type including, but not limited to, video, audio, Internet content etc.

Referring now to FIG. 13, a method 1300 of delivering text messages is shown. First, terminal(s) for receiving text messages are identified to the gateway [step 1302]. The gateway may then receive a text message from a source via the external network [step 1304]. The gateway device may then transmit/push the text message to the previously identified terminal(s). In one non-limiting example, a terminal for receiving text messages may be a DECT phone.

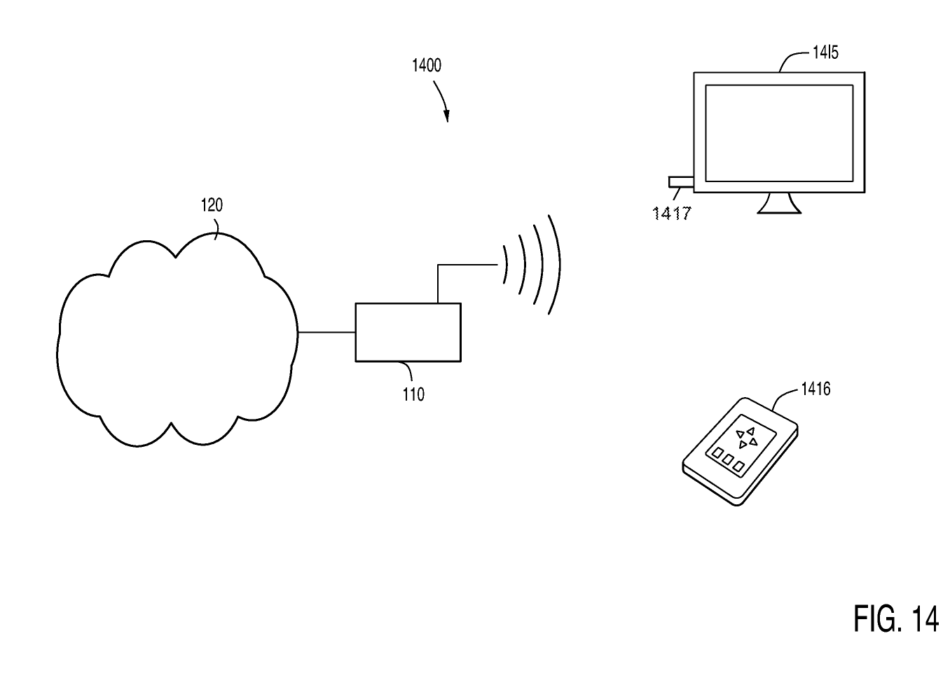

Referring now to FIG. 14, an illustrative system 1400 is shown where one of the terminals includes a remote control 1416. The remote control 1416 is configured to receive user input and communicate the user input to the gateway device 110. In at least one embodiment, in response to the user input, the gateway device 110 may perform any suitable action and/or transmit any suitable data or communication to another terminal 1415 in the system 1400. For example, and without limitation, a user may input a change channel command via the remote control 1416 whereby the gateway device 110 will communicate with the external network 120 so as to receive data associated with a different channel whereby the data associated with the different channel may then be communicated by the gateway device 110 to any suitable terminal 1415 (e.g. a television monitor, etc.). It will be appreciated that any suitable command or input may be received by the remote control 1416 and communicated to the gateway device 120—including, but not limited to, commands for a DVR device or function, smart meter reading and controls, closed-circuit television controls, etc., and that in response thereto, the gateway device 110 may perform any suitable action and/or transmit any suitable data and/or communication to any suitable terminal in the system 1400. Given this disclosure as a whole, those skilled in the art will now appreciate the numerous uses a remote control may have in a system 1400.

The remote control 1416 may take any suitable form. An illustrative block diagram for a remote control 1416 will be further discussed in detail below. However, it will be appreciated that the remote control 1416 may take any suitable form and remain within the scope of the present disclosure. In one embodiment, the remote control 1416 includes a touchscreen for displaying virtual buttons to the user and receiving user input. In another embodiment, the remote control 1416 is a smartphone with an application adapted to allow the smartphone to perform the functionality described herein. In another embodiment, the remote control is a tablet computer with an application adapted to allow the computer the perform the functionality described herein.

In one embodiment, the remote control 1416 includes a communications unit for communicating with the gateway device 110. The communications unit may be configured to provide communications between the gateway device 110 using any suitable communications means or protocol, including but not limited to, Bluetooth, IR, NFC, WiFi, wireless radio or any other suitable communications means or protocol. In an alternative embodiment as also shown in FIG. 14, a dongle 1417 may be employed to provide a communications link between the remote control 1416 and the gateway device 110. The dongle 1417 may communicate with the gateway device employing any suitable communication means or protocol including, but not limited to, all of the communications means and protocols mentioned throughout. In several non-limiting examples, such a dongle may include the FLPR Universal Remote Control dongle from New Potato Technologies, Inc.; the L5 Remote from L5 Technology; and the Zapper TV Remote Control Dongle for Cell phones/tablets offered by VooMote. However, it will be appreciated that any suitable means, device and/or protocol for providing communication between the gateway device 110 and remote control 1416 may be employed and remain within the scope of the present disclosure.

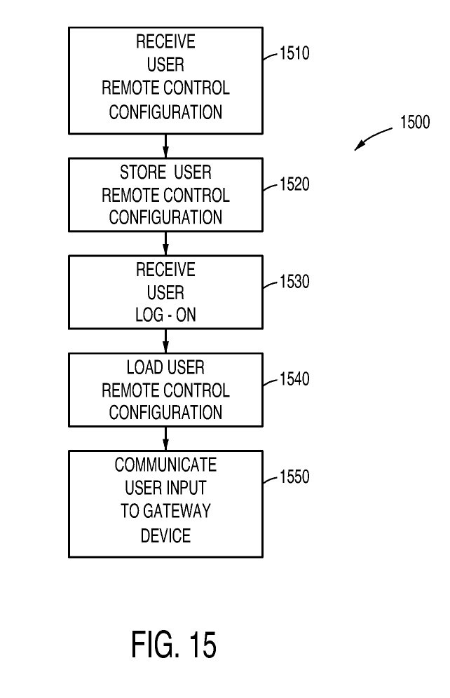

Referring now to FIG. 15, a method 1500 of employing the remote control of the present disclosure is shown. First, a user configuration is provided to the remote control [step 1510]. The user configuration may be provided to the remote control via any suitable means (e.g. direct entry via an I/O device—touchscreen, keypad, etc., remote entry via another computer or terminal, etc.). In one embodiment, the user configuration includes a user-selected display arrangement for display on a touchscreen based remote, smartphone and/or computer (e.g. tablet computer). For example, and without limitation, the user configuration may include user-selected virtual buttons for display, size and/or font associated with any such virtual button(s), the placement of the virtual buttons on the display and/or relative to one another on the display, etc. Also, in one embodiment, one or more standard buttons (e.g. not user-selected) are included as part of the user configuration such that the user configuration includes a combination of user-selected buttons and standard buttons for display. Once the user configuration is received, the user configuration is stored [step 1520]. The user configuration may be stored on the remote control, a removable memory in the remote control (e.g. SD card, etc.), and/or the gateway device. A plurality of user configurations may be stored on the remote control so that each user may have a personalized display for the remote control.

A user may then log into the remote [step 1530]. The user may log into the remote via any suitable means including, but not limited to, touchscreen/keypad user name and password, a biometric input, voice input, or any other suitable means for receiving a user log on. Once the user has been logged into the remote control, the user configuration may be loaded by the remote control [step 1540]. When the user configuration is loaded, the previous user-selected display and arrangement are loaded and displayed by the remote control. The user may then input commands and/or data for communication to the gateway device [step 1550]. As previously discussed, in response the gateway device may perform any suitable action and/or communicate any suitable communication, information and/or data.

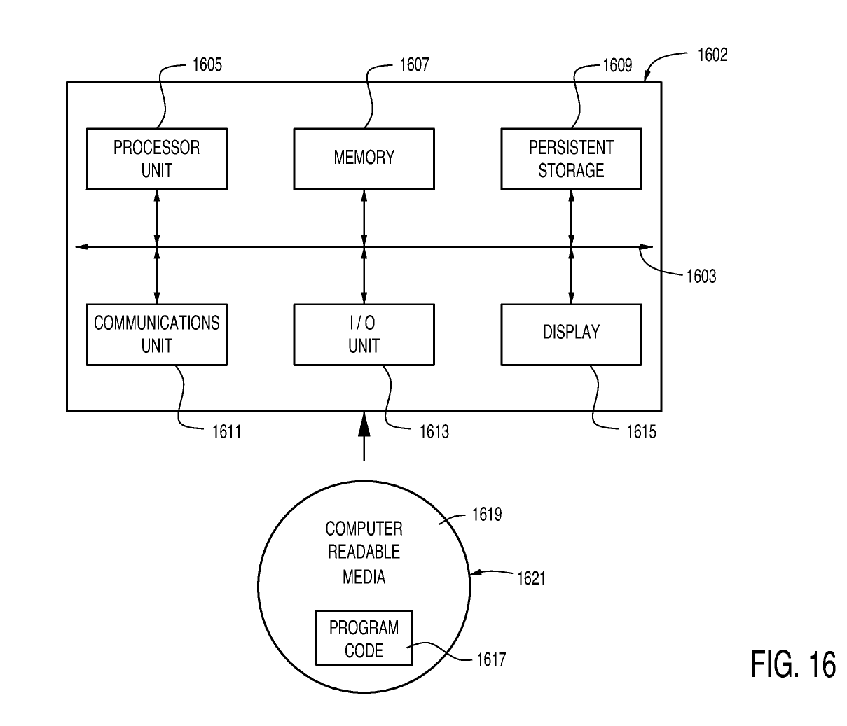

Referring to FIG. 16, a block diagram of a remote control 1602 is shown in which the illustrative embodiments may be implemented. Computer-usable program code or instructions implementing the processes used in the illustrative embodiments may be located on the remote control 1602. The remote control 1602 includes a communications fabric 1603, which provides communications between a processor unit 1605, a memory 1607, a persistent storage 1609, a communications unit 1611, an input/output (I/O) unit 1613, and a display 1615.

The processor unit 1605 serves to execute instructions for software that may be loaded into the memory 1607. The processor unit 1605 may be a set of one or more processors or may be a multi-processor core, depending on the particular implementation. Further, the processor unit 1605 may be implemented using one or more heterogeneous processor systems in which a main processor is present with secondary processors on a single chip. As another illustrative example, the processor unit 1605 may be a symmetric multi-processor system containing multiple processors of the same type.

The memory 1607, in these examples, may be, for example, a random access memory or any other suitable volatile or non-volatile storage device. The persistent storage 1609 may take various forms depending on the particular implementation. For example, the persistent storage 1609 may contain one or more components or devices. For example, the persistent storage 1609 may be a hard drive, a flash memory, a rewritable optical disk, a rewritable magnetic tape, or some combination of the above. The media used by the persistent storage 1609 also may be removable. For example, a SD card or other suitable storage device may be used for the persistent storage 1609.

The communications unit 1611, in these examples, provides for communications with at least the gateway device and optionally one or more terminals. The communications unit 1611 may provide communications through the use of either or both physical and wireless communication links. In one embodiment, the communications unit 1611 is configured to communicate with the gateway device via at least one of Bluetooth, IR, NFC, WiFi, wireless radio or any other suitable means or protocol.

The input/output unit 1613 allows for the input and output of data with other devices that may be connected to the remote control 1602. For example, the input/output unit 1613 may provide a connection for user input through a keyboard, keypad, touchpad, touchscreen, microphone or any other suitable means. Further, the input/output unit 1613 may send output to a processing device. In the case in which the remote control 1602 is a smartphone, the input/output unit 1613 may also allow devices to be connected to the cellular phone, such as microphones, headsets, and controllers. The display 1615 provides a mechanism to display information to a user, such as a graphical user interface.

Instructions for the operating system and applications or programs are located on the persistent storage 1609. These instructions may be loaded into the memory 1607 for execution by the processor unit 1605. The processes of the different embodiments may be performed by the processor unit 1605 using computer-implemented instructions, which may be located in a memory, such as the memory 1607. These instructions are referred to as program code, computer-usable program code, or computer-readable program code that may be read and executed by a processor in the processor unit 1605. The program code in the different embodiments may be embodied on different physical or tangible computer-readable media, such as the memory 1607 or the persistent storage 1609.

Program code 1617 is located in a functional form on a computer-readable media 1619 and may be loaded onto or transferred to the remote control 1602 for execution by the processor unit 1605. The program code 1617 and the computer-readable media 1619 form computer program product 1621 in these examples. In one embodiment, the program code 1617 may include computer-usable program code capable of performing any of the previously described functionality related to the remote control.

In one example, the computer-readable media 1619 may be in a tangible form, such as, for example, SD card or flash memory device that is inserted or placed into a drive or other device that is part of the persistent storage 1609 for transfer onto a storage device, such as a hard drive that is part of the persistent storage 1609. In a tangible form, the computer-readable media 1619 also may take the form of a persistent storage, such as a hard drive or a flash memory that is connected to the remote control 1602. The tangible form of the computer-readable media 1619 is also referred to as computer recordable storage media.

Alternatively, the program code 1617 may be transferred to the remote control 1602 from the computer-readable media 1619 through a communication link to the communications unit 1611 or through a connection to the input/output unit 1613. The communication link or the connection may be physical or wireless in the illustrative examples. The computer-readable media 1619 also may take the form of non-tangible media, such as communication links or wireless transmissions containing the program code 1617. In one embodiment, the program code 1617 is delivered to the remote control 1602 over the Internet.

The different components illustrated for the remote control 1602 are not meant to provide architectural limitations to the manner in which different embodiments may be implemented. The different illustrative embodiments may be implemented in a data processing system including components in addition to or in place of those illustrated for remote control 1602. Other components shown in FIG. 16 can be varied from the illustrative examples shown.

As one example, a storage device in the remote control 1602 is any hardware apparatus that may store data. The memory 1607, the persistent storage 1609, and the computer-readable media 1619 are examples of storage devices in a tangible form.

In another example, a bus system may be used to implement the communications fabric 1603 and may be comprised of one or more buses, such as a system bus or an input/output bus. Of course, the bus system may be implemented using any suitable type of architecture that provides for a transfer of data between different components or devices attached to the bus system. Additionally, the communications unit 1611 may include one or more devices used to transmit and receive data. Further, a memory may be, for example, the memory 1607 or a cache such as found in an interface and memory controller hub that may be present in the communications fabric 1603. It will be appreciated that the communications fabric 1603 may take any suitable form including, but not limited to, non-blocking switch fabric, non-blocking point-to-point/multi-point link or any other suitable communication fabric of communications path(s) between the various elements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements. Also, as used herein, including in the claims, the terms first, second, third, etc. . . . used in relation to an element are for reference or identification purposes only, and these terms, unless otherwise indicated, are not intended to describe or suggest a number, order, source, purpose, or substantive quality for any element for which such a term is used.

1. A local network system comprising:
a plurality of terminals operable to act as a clients on a local network, wherein at least one terminal is a remote control configured to receive user input and wherein at least one terminal is a monitor configured to display multimedia data;
a gateway device operable to manage communications between the one or more terminals and an external network, the gateway device comprising:
a memory configured to store a set of instructions;
a processor configured to execute the set of instructions;
a first communications module in communication with the external network;
a second communications module in communication with the remote control and first communications module, wherein at least some commands received from the remote control by the second communications module are communicated to the external network by way of the first communications module; and
a third communications module in communication with the monitor, the first communications module and at least one other communications module, wherein multimedia data received from the external network via the first communications nodule or multimedia data from the at least one other communications module in communications with another terminal is communicated to the monitor by the third communications module; and
a fourth communications module in communication with at least one other terminal, wherein at least some commands received from the remote control by the second communications module are communicated to the at least one other terminal by the fourth communications module.

2. The system of claim 1 wherein the remote control comprises a memory configured to store a set of instructions; and a processor configured to execute the set of instructions.

3. The system of claim 2 wherein the remote control instructions cause the remote control processor to receive a user configuration for the remote control; and store the user configuration.

4. The system of claim 3 wherein the remote control instructions further cause the remote control processor to receive a user log on; and load the stored user configuration based on the received user log-on.

5. The system of claim 4 wherein the remote control includes a display and wherein the user configuration includes one or more user-selected virtual buttons for display on the remote control display.

6. The system of claim 5 wherein the user configuration includes one or more standard buttons that are displayed with the user-selected buttons when the user configuration is loaded.

7. The system of claim 1 wherein the remote control includes a touchscreen.

8. The system of claim 1 wherein the remote control is a smartphone.

9. The system of claim 1 wherein the remote control is a tablet computer.

10. The system of claim 1 further comprising a dongle in communication with the remote control and configured to provide a communication link between the gateway device and the remote control.

11. A method of employing a remote control in a local network system, the local network system comprising a gateway device and one or more terminals, wherein at least one terminal is a remote control, the method comprising:
receiving a user configuration for the remote control;
storing the user configuration for the remote control;
receiving a user log-on for the remote control; and
loading the stored user configuration for the remote control, wherein the user configuration enables a user command from the remote control to the gateway device on the local network; and wherein said user command is then transmitted from the gateway device to control one or more terminals.

12. The method of claim 11 wherein the remote control includes a display and wherein the user configuration includes one or more user-selected buttons for display on the remote control display.

13. The method of claim 12 wherein the user configuration includes one or more standard buttons that are displayed with the user-selected buttons when the user configuration is loaded.

14. A remote control for use in a local network system, the system comprising a gateway device in communication with one or more terminals and the remote control, the remote control comprising:
memory configured to store a set of instructions;
a processor configured to execute the set of instructions, wherein the instructions cause the processor to:
receive a user configuration for the remote control; and
store the user configuration for the remote control, wherein the user configuration enables a user command from the remote control to the gateway device on the local network; and wherein said user command is then transmitted from the gateway device to control one or More terminals.

15. The remote control of claim 14 wherein the instructions further cause the processor to: receive a user log-on for the remote control; and load the stored user configuration for the remote control based on the received user log-on.

16. The remote control of claim 14 wherein the remote control includes a display wherein the user configuration includes one or more user-selected buttons for display on the remote control.

17. The remote control of claim 14 further comprising a dangle in communication with the remote control and configured to provide a communication link between the gateway device and the remote control.
